(19) United States
(12) Patent Application Publication
(10) Pub. No.: US 2021/0397545 A1
(43) Pub. Date: Dec. 23, 2021

(54) Method and System for Crowdsourced Proactive Testing of Log Classification Models

(71) Applicant: INTERNATIONAL BUSINESS MACHINES CORPORATION, ARMONK, NY (US)

(72) Inventors: Xiaotong Liu, San Jose, CA (US); Anbang Xu, San Jose, CA (US); Rama Kalyani T. Akkiraju, Cupertino, CA (US)

(21) Appl. No.: 16/904,416

(22) Filed: Jun. 17, 2020

(51) Int. Cl. G06F 11/36; G06K 9/62; G06F 11/34

(52) U.S. Cl. CPC G06F 11/3688; G06F 11/3476; G06K 9/6267; G06F 11/3696

(57) ABSTRACT

A system configured to proactively test a log classification model using crowdsourcing, the system comprising memory for storing instructions, and a processor configured to execute the instructions to receive the log classification model as input; provide an explanation for predictions made by the log classification model to a crowd; receive a test sample from a first crowd worker, the test sample is intended to generate an error for the log classification model; generate a prediction using the log classification model based on the test sample as input; receiving validation data corresponding to the prediction of the log classification model; receive categorization data of the error corresponding to the test sample; and improve the log classification model based on the test sample.

### BACKGROUND

Logs are usually created by network devices, applications, operating systems, and programmable or smart devices. It is a common practice to record detailed system runtime information into logs, allowing developers and site reliability engineers to understand system behaviors and localize system faults and problems that may arise. Logs are inherently unstructured, since system events can be recorded by developers using any text for the purpose of convenience and flexibility.

The amount of log data generated by machines far outpaces humans' ability to absorb, interpret, and make complex decisions accordingly. Artificial Intelligence (AI) technology makes it possible for machines to learn from experience, adjust to new inputs, and perform human-like tasks. Fulfilling the promise of AI—solving complex decision problems—depends on the ability to provide the underlying algorithms with domain specific information. For example, to interpret and understand these computer-generated messages, log classification seeks to categorize log messages into system logs, programming logs, network logs, and so on, which are used to build customized log parsers and anomaly detection models.

### SUMMARY

In an embodiment, a method for proactively testing a log classification model using crowdsourcing is disclosed. The method receives the log classification model as input. The method provides an explanation for predictions made by the log classification model to a crowd. The method receives a test sample from a first crowd worker. The test sample is intended to generate an error for the log classification model. The method generates a prediction of the log classification model using the test sample as input. The method receives validation data corresponding to the prediction of the log classification model. The method receives categorization data of the error corresponding to the test sample. The categorization data categorizes the error into one of a plurality of error categories. The method improves the log classification model based on the test sample.

In another embodiment, a computer program product for proactively testing a log classification model using crowdsourcing is disclosed. The computer program product includes a computer readable storage medium having program instructions embodied therewith. The program instructions are executable by a processor of a system to cause the system to receive the log classification model as input; provide an explanation for predictions made by the log classification model to a crowd; receive a test sample from a first crowd worker, the test sample is intended to generate an error for the log classification model; generate a prediction of the log classification model using the test sample as input; receiving, from a second crowd worker, validation data corresponding to the prediction of the log classification model; receive, from a third crowd worker, categorization data of the error corresponding to the test sample, wherein the categorization data categorizes the error into one of a plurality of error categories; and improve the log classification model based on the test sample.

Other embodiments and advantages of the disclosed embodiments are further described in the detailed description.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic drawing illustrating a typical AI model testing process.

FIG. 2 is a schematic drawing illustrating a proactive AI model testing process in accordance with an embodiment of the present disclosure.

FIG. 3 is a schematic drawing of a proactive AI model test system in accordance with an embodiment of the present disclosure.

FIG. 4 is a chart illustrating a set of error categories in accordance with an embodiment of the present disclosure.

FIG. 5 is a chart illustrating a set of ratings and corresponding severity level in accordance with a disclosed embodiment.

FIG. 6 is a schematic drawing illustrating features of a named entity recognition (NER) in accordance with an embodiment of the present disclosure.

FIG. 7 is a chart illustrating adversarial examples in accordance with an embodiment of the present disclosure.

FIG. 8 is a flowchart illustrating a process for proactively testing an AI model using crowdsourcing in accordance with an embodiment of the present disclosure.

FIG. 9 is a block diagram illustrating a hardware architecture of a system in accordance with an embodiment of the present disclosure.

The illustrated figures are only exemplary and are not intended to assert or imply any limitation with regard to the environment, architecture, design, or process in which different embodiments may be implemented.

### DETAILED DESCRIPTION

Collecting sets of complete, accurate, and unbiased training data is an iterative and ongoing process for improving AI systems. As more and more training data is added from different sources, AI systems should be iteratively and dynamically tested to adapt to rapid changes in practice. To this end, the disclosed embodiments propose proactive testing; a novel approach that evaluates the performance of AI models with dynamic and well-crafted dataset collected using crowd intelligence. Proactive testing differs from conventional testing metrics in two aspects. First, it extends the coverage of the testing dataset by dynamically collecting external datasets. Second, AI developers are allowed to query additional dataset belonging to certain categories to target corner cases. As a result, proactive testing is an approach to discovering unknown error and bias of a model, and providing a complete evaluation of the model's performance regarding more comprehensive test cases.

Additionally, the present disclosure proposes a new intelligent system that combines human intelligence and machine learning techniques to assist developers in the process of proactive testing. The disclosed embodiments include four main components: explanation-based error generation, error validation, categorization, and analysis. The embodiments include the use of crowd force in error generation and encourage the crowd to craft sentences that can fail a given log classification model. Leveraging machine learning and visualization techniques, the disclosed embodiments provide an explanation of log classification model predictions to the crowd and saves time and effort in the error generation process. In addition, the disclosed embodiments employ the crowd in error validation and categorization to ensure the quality of the crafted dataset at scale. Using the disclosed embodiments, developers can discover unknown errors made by the log classification models and gain more insights into the continuous improvement of the models for more reliable log analysis.

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to.” Unless otherwise indicated, as used throughout this document, “or” does not require mutual exclusivity, and the singular forms “a”, “an” and “the” are intended to include the plural forms as well, unless the context clearly indicates otherwise.

A module or unit as referenced herein may comprise one or more hardware or electrical components such as electrical circuitry, processors, and memory that may be specially configured to perform a particular function. The memory may be volatile memory or non-volatile memory that stores data such as, but not limited to, computer executable instructions, machine code, and other various forms of data. The module or unit may be configured to use the data to execute one or more instructions to perform one or more tasks. In certain instances, a module may also refer to a particular set of functions, software instructions, or circuitry configured to perform a specific task. For example, a module may comprise of software components such as, but not limited to, data access objects, service components, user interface components, application programming interface (API) components; hardware components such as electrical circuitry, processors, and memory; and/or a combination thereof. As referenced herein, computer executable instructions may be in any form including, but not limited to, machine code, assembly code, and high-level programming code written in any programming language.

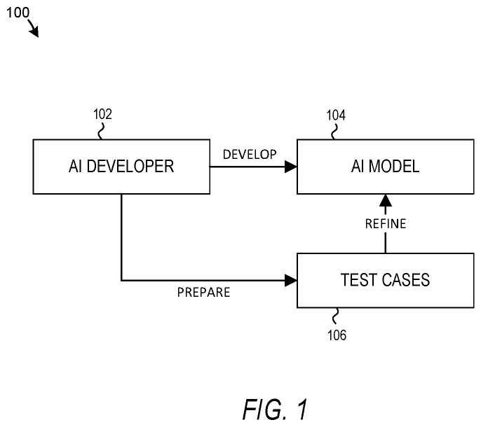

FIG. 1 is a schematic drawing illustrating a typical AI model testing process 100. The typical AI model testing process 100 begins with an AI developer 102 developing an AI model 104. In order to test the model 104, the AI developer 102 prepares a set of test cases 106 that is used as input for the AI model 104. The results of these test cases are then used to refine/improve the AI model 104. To continuously improve the performance of AI model 104, the AI developer 102 repeats the typical AI model testing process 100. In general, it is very time-consuming for the AI developer 102 to continuously prepare the test cases 106 in order to refine the AI model 104.

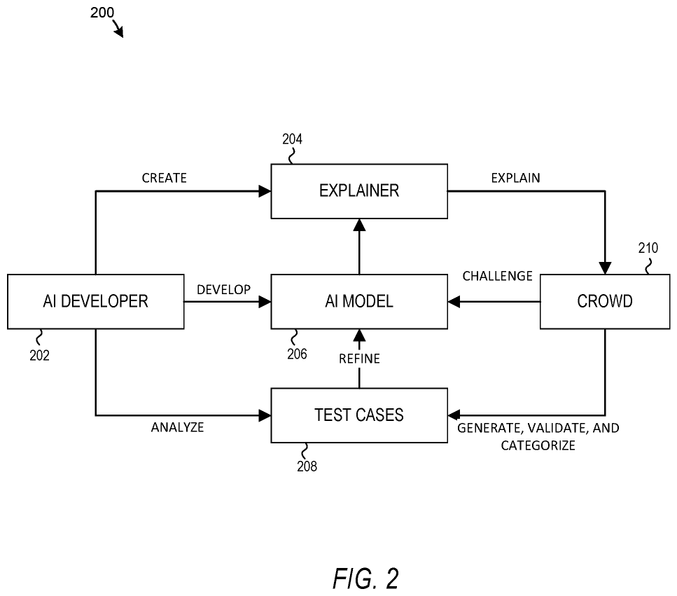

FIG. 2 is a schematic drawing illustrating a proactive AI model testing process 200 in accordance with an embodiment of the present disclosure. Similar to the typical AI model testing process 100, the proactive AI model testing process 200 begins with an AI developer 202 developing an AI model 204. However, instead of the AI developer 202 preparing a set of test cases 208 that is used to refine the AI model 206 as done in the typical AI model testing process 100, the AI developer 202 creates an Explainer 204, which is configured to explain the AI model 206 to a crowd 210 by providing interpretable results for the model's predictions. Depending on the particular task and the knowledge required, the crowd 210 can be made up of various types of users including, but not limited to, internal users within a group, all employees of an organization, and/or any open public user. The proactive AI model testing process 200 employs users or workers from the crowd 210 (i.e., crowd workers) to generate, validate, and categorize the set of test cases 208, which are then used as input to refine the AI mode 1206. The Explainer 204 can also be refined to provide better explanations based on the set of test cases 208 are generated by the crowd 210. For example, after a worker submits a test case (e.g., a sentence), the Explainer 204 analyzes the relationship between the prediction and each word in real time. Then the results are presented to workers to comprehend. In certain embodiments, the crowd 210 can also challenge the predictions of the AI mode 1206. For example, if a particular test case 208 does not fail the AI mode 1206, the crowd 210 can modify some of the inputs until the AI model 206 fails.

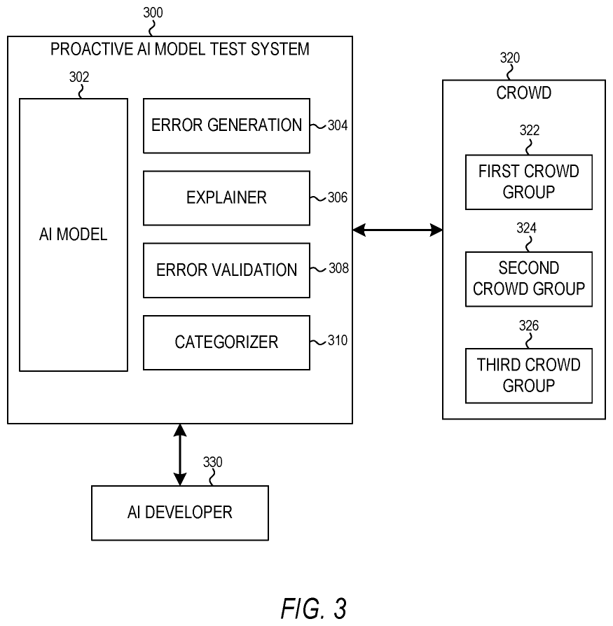

FIG. 3 is a schematic drawing of a proactive AI model test system 300 in accordance with an embodiment of the present disclosure. The proactive AI model test system 300 can be used to implement the proactive AI model testing process 200 of FIG. 2. In the depicted embodiment, the proactive AI model test system 300 includes an AI model 302, and error generation module 304, an explainer module 306, an error validation module 308, and a categorizer module 310. The AI model 302 is developed and initially trained by an AI developer 330. In an embodiment, the AI model 302 is a text classifier such as, but not limited to, a NER model or a log classification model. A NER model is a model that trained to locate and classify named entities mentioned in unstructured text into pre-defined categories such as names, actions, components, etc. For example, a NER model can be trained to identify anomalies from the log data of a system that indicate an attempted security attack or that the system is stuck and requires intervention. A log classification model is a model that trained to identify and classify information in unstructured log data produced by a system. In an embodiment, the log classification model is used to categorize a log into one of a plurality of predefined log category types such as, but not limited to, system logs, information logs, and error logs. For example, the log classification model may categorize a log as an error log by identifying errors based one or more error templates that describe the parameters of an error.

In accordance with the disclosed embodiments, the proactive AI model test system 300 can proactively test any type of AI model 302 by employing a crowd 320 to generate testing datasets that challenge and fail the AI model 302. Communication between the proactive AI model test system 300 and the crowd 320 can be local or remote. Remote communications can be over any type of network including public and private networks using any suitable electronic device. In certain embodiments, a user within the crowd 320 must request and be granted access to the proactive AI model test system 300 prior to interacting with the proactive AI model test system 300. In some embodiments, the crowd 320 can be broken into various types of groups such as, but not limited to, the first crowd group 322, a second crowd group 324, and third crowd group 326. Each group may be assigned a particular task associated with the proactive AI model test system 300, or may be used to crosscheck the work produced by other crowd workers.

In an embodiment, the error generation module 304 is configured to enable crowd workers to craft training samples (e.g., sentences) to challenge and fail the AI model 302. These training samples are often referred to as adversarial examples, which are inputs to machine learning models that the creator has intentionally designed to cause the model to make a mistake/fail (i.e., make a wrong prediction). By generating a lot of adversarial examples and explicitly training the AI model 302 with the adversarial examples, the AI model 302 can be trained to make correct predictions when encountering the same examples in test cases or during live predictions. Thus, the more adversarial examples that can be generated and used to train the AI model 302, the better the AI model 302 can perform. Therefore, in accordance with the disclosed embodiments, the error generation module 304 is configured to communicate with and provide a user interface to crowd workers from the crowd 320 to generate the adversarial examples for training the AI model 302. The crowd workers can either craft a test sample from scratch, or edit an auto-generated test sample or sentence by the system from a known error category. In an embodiment, the error generation module 304 is configured to enable a crowd worker to interactively modify a training sample until the AI model fails. In an embodiment, the crowd workers from the first crowd group 322 are assigned the tasked of generating the testing datasets that challenge and fail the AI model 302.

In an embodiment, to assist the crowd 320 in generating the testing datasets, the explainer module 306 is configured to explain a given AI model by providing interpretable results for the model's predictions. In an embodiment, the explainer module 306 is configured to utilize Local Interpretable Model-Agnostic Explanations (LIME), a machine learning technique to explain how a specific prediction was made by the AI model 302 (i.e., the rationale behind a prediction). In general, LIME treats the AI model 302 as a black-box and perturbs a training instance (i.e., creates various combinations of the input by removing certain words) and identifies how the predictions change based on the various inputs. LIME then constructs a locally weighted regression model, which is used to rank features or words in the training instance. The explainer module 306 uses the locally weighted regression model to derive an explanation for the prediction of the AI model 302 based on the training instance input (i.e., quantify the contribution of each word/feature to a final prediction). For example, in an embodiment, after a crowd worker submits a sentence as a test instance, the explainer module 306 analyzes the relationship between the prediction generated by the AI model 302 and each word in the sentence. The results (i.e., contribution/weight of each word) are then presented to crowd worker to comprehend. In an embodiment, instead of presenting a set of numeric values, the explainer module 306 provides visual explanations to intuitively depict the results along with the text (e.g., the background color of a word indicates whether it contributes to positive (green), negative (red), or neutral (yellow) sentiment).

In an embodiment, the error validation module 308 is configured to enable crowd workers to validate the results of the AI model 302 (e.g., validate ground truth labels) for a particular dataset or test case/instance. In an embodiment, to provide quality control, the error validation module 308 assigns a different group of crowd workers to validate the results of test cases created by a particular group of crowd workers. As an example, the error validation module 308 can assign the second crowd group 324 the task of validating the results of the AI model 302 based on the testing dataset generated by the first crowd group 322. In an embodiment, the error validation module 308 is configured to employ multiple crowd workers to validate one sample and base the validation result on a majority decision of the crowd workers. In an embodiment, the error validation module 308 is configured to only validate sentences that are labeled to have failed the AI model 302. In an embodiment, the proactive AI model test system 300 is configured to offer an “effort-responsive” bonus or some form of incentive (e.g., monetary) to the creator of the test case based on the validation results. In an embodiment, a good test sample should minimally satisfy two criteria. First, the test sample has to be syntactically correct from the language viewpoint. Second, the test sample has to successfully fail the AI model 302 (i.e., make the AI model 302 predict incorrectly). As another quality control measurement, the error validation module 308 can be configured to provide test questions to the crowd worker that is performing validation to ensure that the crowd worker is knowledgeable. In an embodiment, the error validation module 308 rejects the validation data from any crowd worker that fails a predetermined number of the test questions.

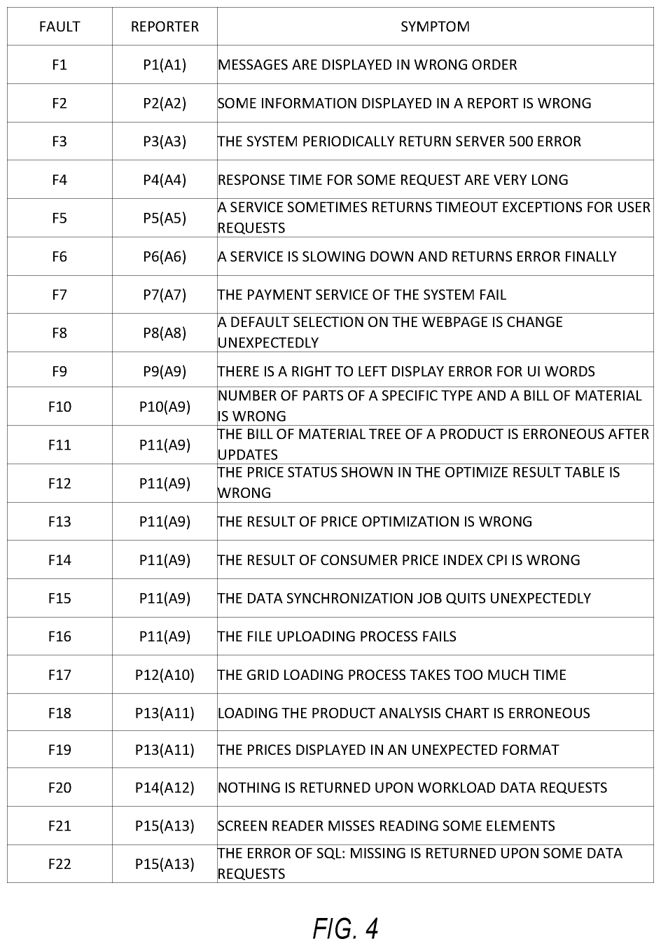

In an embodiment, the categorizer module 310 is configured to categorize the error cases into one or more categories. In an embodiment, another set of crowd workers can be assigned the task of categorizing the error cases after the error validation process. For example, the third crowd group 326 can be assigned the task of categorizing the error generated by the AI model 302 based on the testing dataset generated by the first crowd group 322 and validated by the second crowd group 324. In an embodiment, an initial set of error categories can be created by the AI developer 330. In some embodiments, the error categories are iteratively refined by crowd workers during the error categorization process. A non-limiting example of a set of error categories is shown in FIG. 4.

In an embodiment, in categorizing the error, the categorizer module 310 is configured to determine the severity/impact of each error. In one embodiment, for a misclassified sentence (i.e., an incorrect prediction), if both the crowd worker and the AI model 302 are confident about the prediction, then the error/mistake is severe. On the other hand, if both sides are not sure about the prediction, then the error/mistake can probably be ignored. In an embodiment, a severity score for each error is calculated as:

S=W1×Conf_human+W2×Conf_AI

In the above equation, W1 and W2 are weights for confidence of human and of the AI model 302, respectively. Conf_human represents the confidence of human, which is calculated as the percentage of the crowd making the judgment the same as majority vote. Conf_AI is a probability or confidence of the prediction provided by the AI model 302.

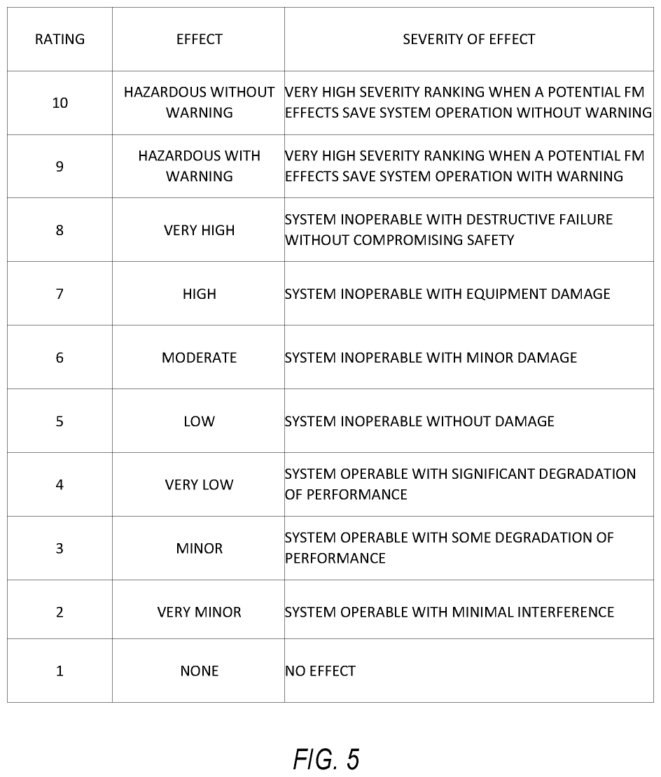

In an embodiment, the severity score of an error is used to determine a rating. For example, FIG. 5 is a chart 500 illustrating a set of ratings and corresponding severity of effect in accordance with a disclosed embodiment. The chart 500 includes a rating 1-10, an effect category, and a description of the severity of the error corresponding to each of the ratings. The effect category can range from none (rating 0) to hazardous without any warning (rating 10).

Referring back to FIG. 3, in some embodiments, the categorizer module 310 is configured to determine a robustness of the error associated with the test sample. The robustness quantifies how suitable the test sample is for a target category. In an embodiment, a robustness score is calculated as:

Robustness=Ncateg/Nvalid

In the above equation, Nvalid is the number of sentences that successfully fail the model based on the validation results. Ncateg is the number of sentences that can fail the model and also belong to the target category. In an embodiment, the proactive AI model test system 300 provides a visual summarization of the severity and robustness distributions of errors across different categories obtained through the process of error generation, validation, and categorization. For example, a stacked bar chart can be used to demonstrate the error distribution of each category at the macro-level. In an embodiment, the x-axis presents different categories while the y-axis shows the number of errors. For each category, two thresholds can be set to split errors into three classes representing different levels of severity, e.g., high (indicated by a first color), middle (indicated by a second color), and low (indicated by a third color).

In summary, the proactive AI model test system 300 can assist the AI developer 330 to better understand the performance of the AI model 302 by analyzing a large quantity of errors based on test cases generated, validated, and categorized using crowdsourcing. In certain embodiments, the AI developer 330 can query (request from the crowd) additional datasets belonging to certain categories to target corner cases (i.e., occurs outside of normal operating parameters). By providing a large quantity of test samples/adversarial examples produced from the crowd, the proactive AI model test system 300 can refine/improve the AI model 302 at a reduced cost and time to the AI developer 330. Additionally, by providing a large quantity of test samples, the proactive AI model test system 300 can discover unknown error and bias of a model, and providing a complete evaluation of the model's performance.

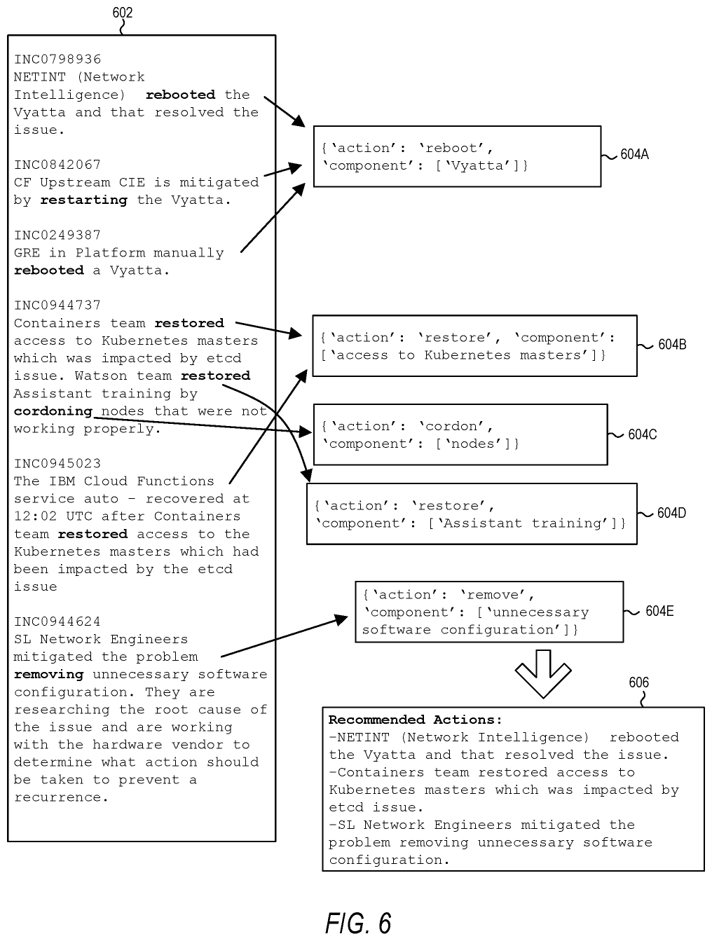

FIG. 6 is a schematic drawing illustrating example features of a NER model in accordance with an embodiment of the present disclosure. In the depicted embodiment, the NER model is trained to identify and extract certain entities from unstructured information contained in a system log 602 to form structured data 604A-604E. The structured data 604A-604E identifies what action is being performed on what component. In an embodiment, using the structured data 604A-604E, the NER model can predict the recommended actions 606 to perform to address the information contained in the system log 602.

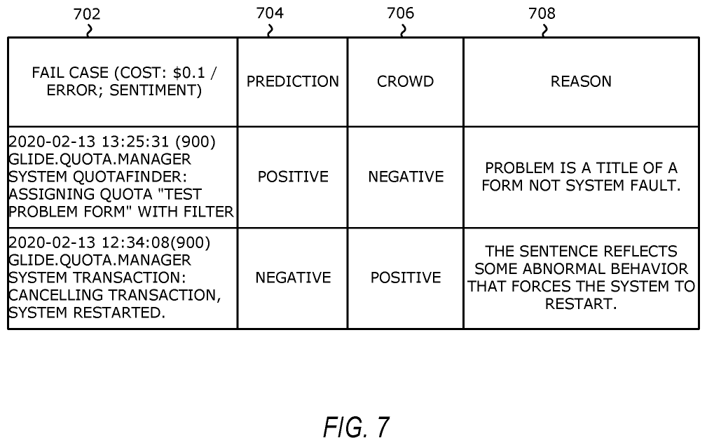

FIG. 7 is a chart 700 illustrating adversarial examples in accordance with an embodiment of the present disclosure. The chart 700 includes two adversarial examples (e.g., sentences) generated by a crowd worker in column 702. Column 704 of the chart 700 indicates the predictions by the AI model of each of the adversarial examples 702. A positive result means that the system detects an anomaly in the test case. A negative result means that there is anomaly in the test case. Column 706 of the chart 700 indicates what the crowd believes should be the result of the model. In both cases, the crowd disagrees with the prediction of the model. In the depicted embodiment, the crowd worker provides a reason in column 708 that supports his/her prediction. The provided reasons can be used to further refine the model.

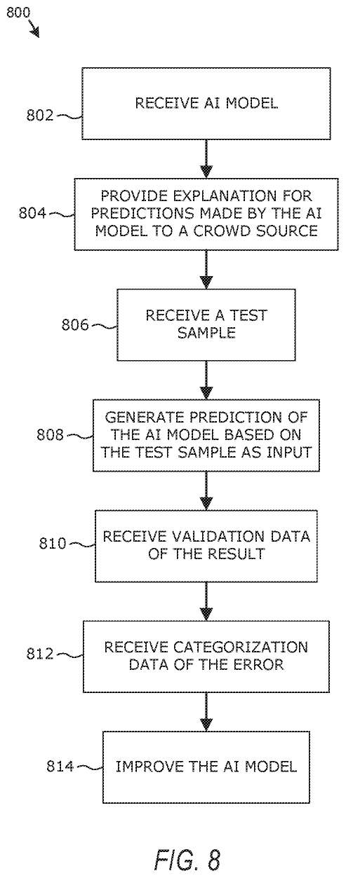

FIG. 8 is a flowchart illustrating a process 800 for proactively testing an AI model using crowdsourcing in accordance with an embodiment of the present disclosure. In an embodiment, the process 800 can be performed by the proactive AI model test system 300 in FIG. 3. The process 800 begins at step 802 by receiving the AI model as input. In an embodiment, the AI model is a log classification model. At step 804, the process 800 provides an explanation for predictions made by the AI model to a crowd. The process 800 at step 806 receives a test sample from a first crowd worker. The test sample is intended to generate an error for the AI model (i.e., AI model fails). The process 800 at step 808 generates a prediction using the AI model based on the test sample as input. At step 810, the process 800 receives validation data corresponding to the prediction of the AI model. The process 800 at step 812 receives categorization data of the error corresponding to the test sample. In an embodiment, the categorization data categorizes the error into one of a plurality of error categories. At step 814, the process improves the AI model based on the test sample.

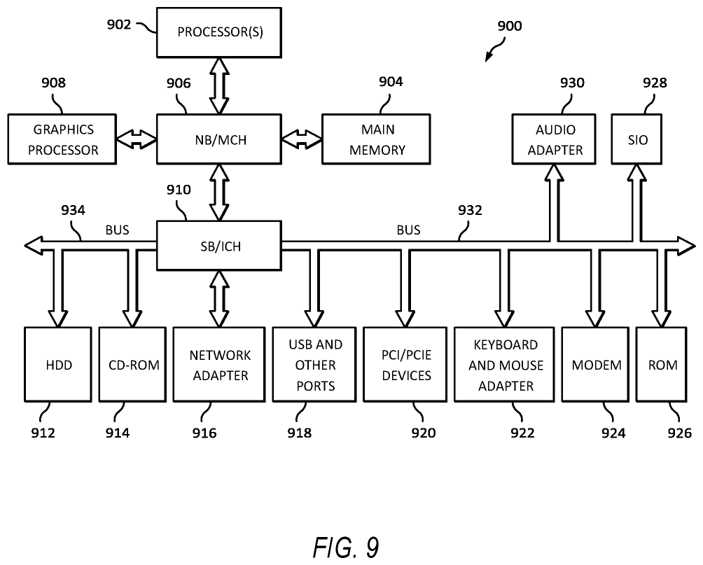

FIG. 9 is a block diagram illustrating a hardware architecture of a system 900 according to an embodiment of the present disclosure in which aspects of the illustrative embodiments may be implemented. For example, the data processing system 900 may be configured to store and execute instructions for performing the process described in FIG. 2 and FIG. 6. In the depicted example, the data processing system 900 employs a hub architecture including north bridge and memory controller hub (NB/MCH) 906 and south bridge and input/output (I/O) controller hub (SB/ICH) 910. Processor(s) 902, main memory 904, and graphics processor 908 are connected to NB/MCH 906. Graphics processor 908 may be connected to NB/MCH 906 through an accelerated graphics port (AGP). A computer bus, such as bus 932 or bus 934, may be implemented using any type of communication fabric or architecture that provides for a transfer of data between different components or devices attached to the fabric or architecture.

In the depicted example, network adapter 916 connects to SB/ICH 910. Audio adapter 930, keyboard and mouse adapter 922, modem 924, read-only memory (ROM) 926, hard disk drive (HDD) 912, compact disk read-only memory (CD-ROM) drive 914, universal serial bus (USB) ports and other communication ports 918, and peripheral component interconnect/peripheral component interconnect express (PCI/PCIe) devices 920 connect to SB/ICH 910 through bus 932 and bus 934. PCI/PCIe devices may include, for example, Ethernet adapters, add-in cards, and personal computing (PC) cards for notebook computers. PCI uses a card bus controller, while PCIe does not. ROM 926 may be, for example, a flash basic input/output system (BIOS). Modem 924 or network adapter 916 may be used to transmit and receive data over a network.

HDD 912 and CD-ROM drive 914 connect to SB/ICH 910 through bus 934. HDD 912 and CD-ROM drive 914 may use, for example, an integrated drive electronics (IDE) or serial advanced technology attachment (SATA) interface. In some embodiments, HDD 912 may be replaced by other forms of data storage devices including, but not limited to, solid-state drives (SSDs). A super I/O (SIO) device 928 may be connected to SB/ICH 910. SIO device 928 may be a chip on the motherboard configured to assist in performing less demanding controller functions for the SB/ICH 910 such as controlling a printer port, controlling a fan, and/or controlling the small light emitting diodes (LEDS) of the data processing system 900.

The data processing system 900 may include a single processor 902 or may include a plurality of processors 902. Additionally, processor(s) 902 may have multiple cores. For example, in one embodiment, data processing system 900 may employ a large number of processors 902 that include hundreds or thousands of processor cores. In some embodiments, the processors 902 may be configured to perform a set of coordinated computations in parallel.

An operating system is executed on the data processing system 900 using the processor(s) 902. The operating system coordinates and provides control of various components within the data processing system 900 in FIG. 9. Various applications and services may run in conjunction with the operating system. Instructions for the operating system, applications, and other data are located on storage devices, such as one or more HDD 912, and may be loaded into main memory 904 for execution by processor(s) 902. In some embodiments, additional instructions or data may be stored on one or more external devices. The processes described herein for the illustrative embodiments may be performed by processor(s) 902 using computer usable program code, which may be located in a memory such as, for example, main memory 904, ROM 926, or in one or more peripheral devices.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An automated method for proactively testing a log classification model using crowdsourcing, the method comprising:
receiving the log classification model as input;
providing an explanation for predictions made by the log classification model to a crowd;
receiving a test sample from a first crowd worker, the test sample is intended to generate an error for the log classification model;
generating a prediction of the log classification model using the test sample as input;
receiving validation data corresponding to the prediction of the log classification model;
receiving categorization data of the error corresponding to the test sample, wherein the categorization data categorizes the error into one of a plurality of error categories; and
improving the log classification model based on the test sample.

2. The automated method according to claim 1 further comprising determining a severity of the error associated with the test sample.

3. The automated method according to claim 1 further comprising determining a robustness of the error associated with the test sample, wherein the robustness quantifies how suitable the test sample is for a target category.

4. The automated method according to claim 1, further comprising receiving the validation data corresponding to the prediction of the log classification model from a second crowd worker.

5. The automated method according to claim 4, further comprising receiving the categorization data of the error corresponding to the test sample from a third worker.

6. The automated method according to claim 4, further comprising:
providing test questions for quality control to the second crowd worker; and
rejecting the validation data from the second crowd worker when the second crowd worker fails a predetermined number of the test questions.

7. The automated method according to claim 1, further comprising evaluating an effectiveness of the explanation for predictions made by the log classification model based on a performance analysis of test samples received from the first crowd worker.

8. The automated method according to claim 1, wherein the test sample is generated by the first crowd worker by editing an auto-generated sentence produced from a known error category.

9. The automated method according to claim 1, further comprising providing a monetary incentive to the first crowd worker based on the validation data.

10. A system configured to proactively test a log classification model using crowdsourcing, the system comprising memory for storing instructions, and a processor configured to execute the instructions to:
receive the log classification model as input;
provide an explanation for predictions made by the log classification model to a crowd;
receive a test sample from a first crowd worker, the test sample is intended to generate an error for the log classification model;
generate a prediction using the log classification model based on the test sample as input;
receiving validation data corresponding to the prediction of the log classification model;
receive categorization data of the error corresponding to the test sample, wherein the categorization data categorizes the error into one of a plurality of error categories; and
improve the log classification model based on the test sample.

11. The system according to claim 10, wherein the processor is further configured to execute the instructions to determine a severity and a robustness of the error associated with the test sample.

12. The system according to claim 10 wherein improving the log classification model comprises determining a bias of the log classification model based on the error associated with the test sample, and correcting the bias of the log classification model.

13. The system according to claim 10, wherein the processor is further configured to execute the instructions to receive the validation data corresponding to the prediction of the log classification model from a second crowd worker, and receive the categorization data of the error corresponding to the test sample from a third worker.

14. The system according to claim 13, wherein the processor is further configured to execute the instructions to query additional test samples belonging to certain error categories to target corner cases.

15. The system according to claim 13, wherein the processor is further configured to execute the instructions to:
provide test questions for quality control to the second crowd worker; and
reject the validation data from the second crowd worker when the second crowd worker fails a predetermined number of the test questions.

16. The system according to claim 10, wherein the processor is further configured to execute the instructions to evaluate an effectiveness of the explanation for predictions made by the log classification model based on a performance analysis of test samples received from the first crowd worker.

17. The system according to claim 10, wherein the test sample is generated by the first crowd worker by editing an auto-generated sentence produced from a known error category.

18. The system according to claim 10, wherein the processor is further configured to execute the instructions to provide an incentive to the first crowd worker based on the validation data.

19. A computer program product for proactively testing a log classification model using crowdsourcing, the computer program product comprising a computer readable storage medium having program instructions embodied therewith, the program instructions executable by a processor of a system to cause the system to:
receive the log classification model as input;
provide an explanation for predictions made by the log classification model to a crowd;
receive a test sample from a first crowd worker, the test sample is intended to generate an error for the log classification model;
generate a prediction of the log classification model using the test sample as input;
receiving, from a second crowd worker, validation data corresponding to the prediction of the log classification model;
receive, from a third crowd worker, categorization data of the error corresponding to the test sample, wherein the categorization data categorizes the error into one of a plurality of error categories; and
improve the log classification model based on the test sample.

20. The computer program product of claim 19, the program instructions executable by the processor of the system to further cause the system to determine a severity and a robustness of the error associated with the test sample.
